(19) United States
(12) Patent Application Publication
(10) Pub. No.: US 2025/0279590 A1
(43) Pub. Date: Sep. 4, 2025

(54) ANTENNA DEVICE

(71) Applicants: Inventec (Pudong) Technology Corporation, Shanghai (CN); INVENTEC CORPORATION, Taipei City (TW)

(72) Inventors: Hsin-Hung LIN, Taipei City (TW); Yu Shu TAI, Taipei City (TW); Wei-Chen CHENG, Taipei City (TW)

(73) Assignees: Inventec (Pudong) Technology Corporation, Shanghai (CN); INVENTEC CORPORATION, Taipei City (TW)

(21) Appl. No.: 18/602,918

(22) Filed: Mar. 12, 2024

(30) Foreign Application Priority Data
Mar. 1, 2024 (CN) 202410238917.9

(51) Int. Cl. H01Q 21/06; H01Q 21/00

(52) U.S. Cl. CPC H01Q 21/065; H01Q 21/0025

(57) ABSTRACT

An antenna device includes a first substrate, a second substrate, a T-shaped exciter and a radiator. The first substrate has a first bottom surface and a first top surface opposite to each other. The second substrate is stacked on the first substrate, and has a second bottom surface and a second top surface opposite to each other. The second bottom surface faces the first top surface. The T-shaped exciter is disposed on the first bottom surface, and includes a head portion and an extending portion. The extending portion is connected to a side of the head portion. The radiator is disposed on the second top surface, and includes two first radiation components and two second radiation components arranged along two diagonals of the radiator, respectively. A size of each of the two first radiation components is different from a size of each of the two second radiation components.

### CROSS-REFERENCE TO RELATED APPLICATIONS

This non-provisional application claims priority under 35 U.S.C. § 119(a) on Patent Application No(s). 202410238917.9 filed in China, on Mar. 1, 2024, the entire contents of which are hereby incorporated by reference.

### BACKGROUND OF THE INVENTION

### Technical Field of the Invention

The invention relates to an antenna device, more particularly to an antenna device including radiator arranged along diagonals.

### Description of the Related Art

With the advancement of wireless communication technology, electronic devices such as mobile phones and personal digital assistants are evolving towards more diversified functions, becoming lighter and thinner, and achieving faster and more efficient data transmission. In particular, wireless communication technology is expected to enter the 6G era by 2030, meeting various life applications and business requirements that 5G has not fulfilled. Specifically, low Earth orbit satellite communication is a key technology for the future commercialization of 6G.

Generally, ground base station antennas serve as the pivotal link between low Earth orbit (LEO) satellite systems and terrestrial communications, converting signals transmitted by satellites into usable data. The antennas are crucial for ensuring stable and efficient communication between ground facilities and LEO satellite. However, the current stability and efficiency of communications between 6G antennas and LEO satellites are still lacking. Therefore, improving the stability and efficiency of communications between antennas and LEO satellites is one of the key challenges that researchers need to address.

### SUMMARY OF THE INVENTION

The invention provides an antenna device so as to improve the stability and efficiency of communications between antenna devices and LEO satellites.

One embodiment of the invention provides an antenna device including a first substrate, a second substrate, a T-shaped exciter and at least one radiator. The first substrate has a first bottom surface and a first top surface opposite to each other. The second substrate is stacked on the first substrate. The second substrate has a second bottom surface and a second top surface opposite to each other. The second bottom surface faces the first top surface. The T-shaped exciter is disposed on the first bottom surface. The T-shaped exciter includes a head portion and an extending portion. The extending portion is connected to a side of the head portion. The at least one radiator is disposed on the second top surface. The at least one radiator includes two first radiation components and two second radiation components. A size of each of the two first radiation components is different from a size of each of the two second radiation components. The two first radiation components are arranged along a diagonal of the at least one radiator. The two second radiation components are arranged along another diagonal of the at least one radiator.

According to the antenna device disclosed by the above embodiment, the size of each of the two first radiation components is different from the size of each of the two second radiation components, and the two first radiation components and the two second radiation components are arranged along the diagonals, respectively. Accordingly, in the two frequency bands ranging from 17.7 gigahertz (GHz) to 20.2 GHz and from 27.5 GHz to 30 GHz, the return losses of the antenna device are low. Therefore, the stability and efficiency of communications between the antenna device and low Earth orbit satellites can be improved.

### BRIEF DESCRIPTION OF THE DRAWINGS

The invention will become more fully understood from the detailed description given herein below and the accompanying drawings which are given by way of illustration only and thus are not limitative of the invention and wherein:

FIG. 1 is a perspective view of an antenna device in accordance with first embodiment of the invention;

FIG. 2 is an exploded view of the antenna device in FIG. 1;

FIG. 3 is a plane view of a T-shaped exciter of the antenna device in FIG. 1;

FIG. 4 is a plane view of a coupling body of the antenna device in FIG. 1;

FIG. 5 is a plane view of a second substrate and a radiator of the antenna device in FIG. 1;

FIG. 6 is a graph showing a return loss data of the antenna device in FIG. 1;

FIG. 7 is a perspective view of an antenna device in accordance with second embodiment of the invention; and

FIG. 8 is a perspective view of an antenna device in accordance with third embodiment of the invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the invention, such as technical and scientific terms, have its own meanings and can be comprehended by those skilled in the art, unless the terms are additionally defined in the invention. That is, the terms used in the following paragraphs should be read on the meaning commonly used in the related fields and will not be overly explained, unless the terms have a specific meaning in the invention.

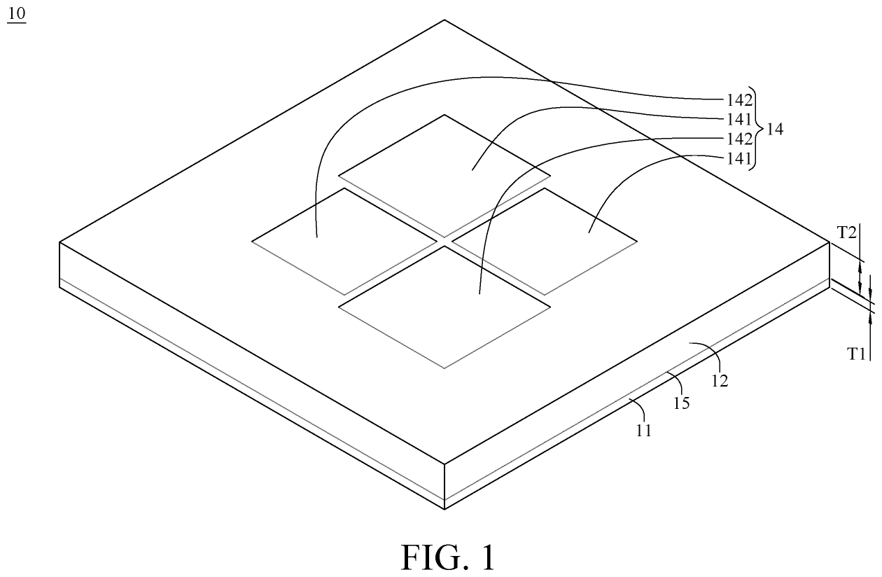

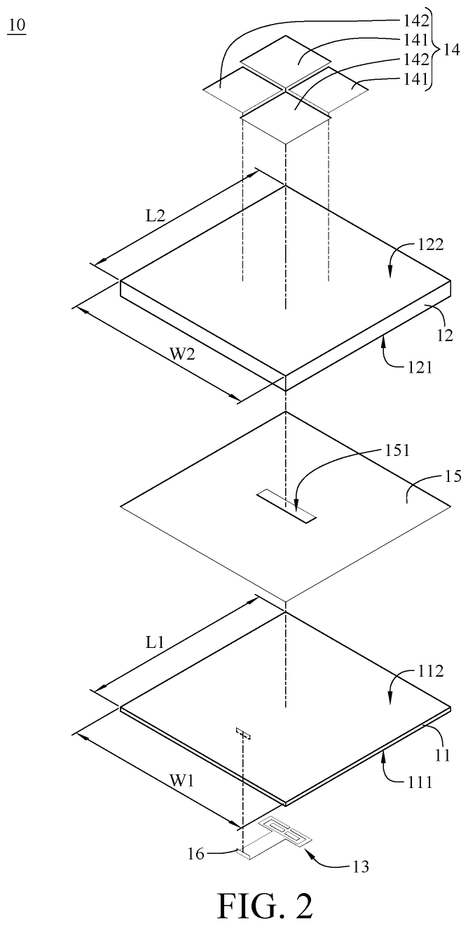

Please refer to FIG. 1 and FIG. 2, where FIG. 1 is a perspective view of an antenna device 10 in accordance with first embodiment of the invention, and FIG. 2 is an exploded view of the antenna device 10 in FIG. 1.

In this embodiment, the antenna device 10 is configured for, for example, low Earth orbit satellite communication, and includes a first substrate 11, a second substrate 12, a T-shaped exciter 13, a radiator 14, a coupling body 15 and a feeding point 16. The first substrate 11 has a first bottom surface 111 and a first top surface 112 opposite to each other. The second substrate 12 is stacked on the first substrate 11. The second substrate 12 has a second bottom surface 121 and a second top surface 122 opposite to each other. The second bottom surface 121 faces the first top surface 112.

In this embodiment, the first substrate 11 and the second substrate 12 are, for example, made of RO4003 glass fiber materials, so that a loss of a signal radiated by the antenna device 10 can be reduced by the RO4003 glass fiber materials.

In this embodiment, a length L1 of the first substrate 11, a width W1 of the first substrate 11, a length L2 of the second substrate 12 and a width W2 of the second substrate 12 are each, for example, 10 millimeters. A thickness T1 of the first substrate 11 is, for example, 0.8 millimeters. A thickness T2 of the second substrate 12 is, for example, 0.2 millimeters.

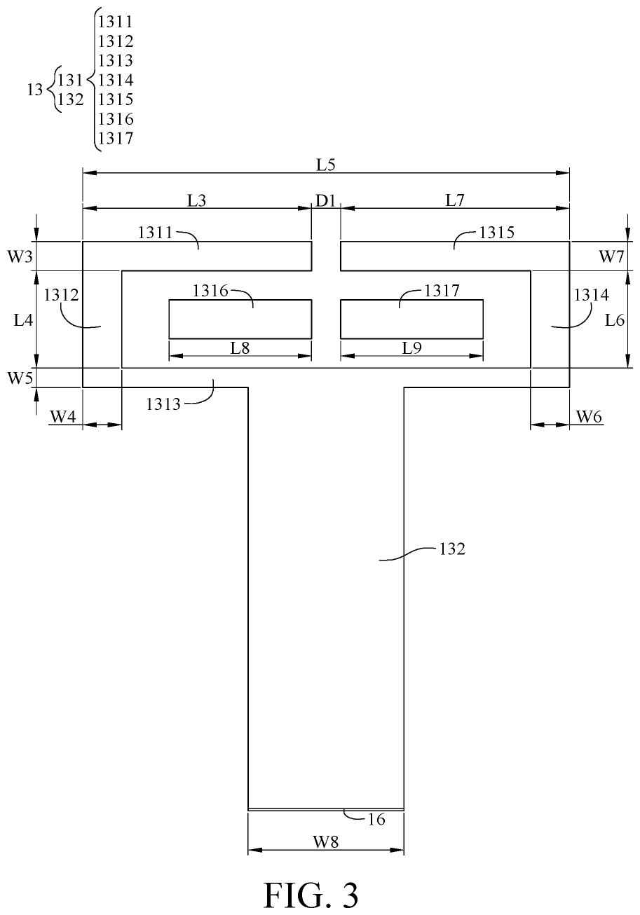

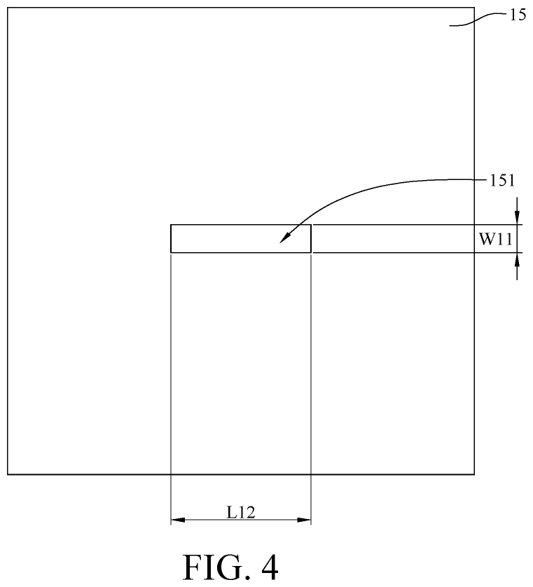

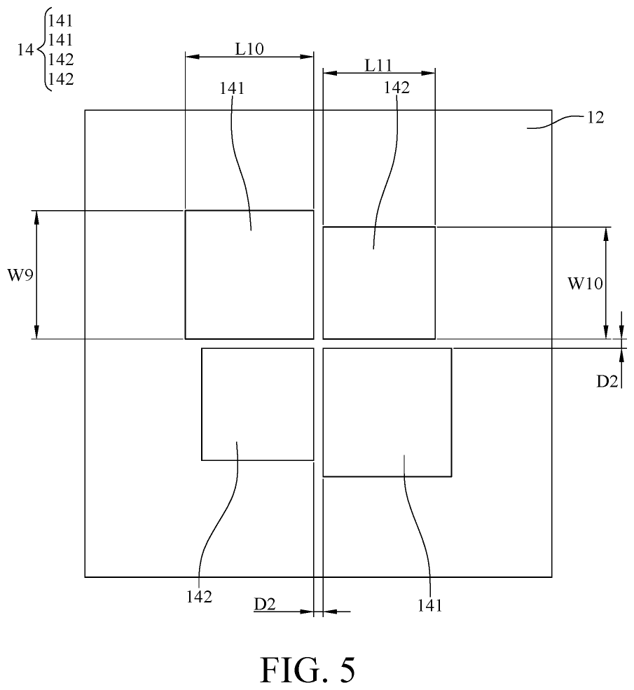

Please refer to FIG. 1 and FIG. 5, where FIG. 3 is a plane view of the T-shaped exciter 13 of the antenna device 10 in FIG. 1, FIG. 4 is a plane view of the coupling body 15 of the antenna device 10 in FIG. 1, and FIG. 5 is a plane view of the second substrate 12 and the radiator 14 of the antenna device 10 in FIG. 1.

The T-shaped exciter 13 is disposed on the first bottom surface 111, and is, for example, made of copper foil. The T-shaped exciter 13 includes a head portion 131 and an extending portion 132. The extending portion 132 is connected to a side of the head portion 131.

In detail, the head portion 131 of the T-shaped exciter 13 has a hollow structure, and includes a first section 1311, a second section 1312, a third section 1313, a fourth section 1314, a fifth section 1315, a sixth section 1316 and a seventh section 1317. An end of the first section 1311 is connected to an end of the second section 1312. Another end of the second section 1312 is connected to an end of the third section 1313. The first section 1311 and the third section 1313 are located on a same side of the second section 1312. Another end of the third section 1313 is connected to an end of the fourth section 1314. The second section 1312 and the fourth section 1314 are located on a same side of the third section 1313. Another end of the fourth section 1314 is connected to an end of the fifth section 1315. The third section 1313 and the fifth section 1315 are located on a same side of the fourth section 1314. Another end of the fifth section 1315 and another end of the first section 1311 are spaced apart from each other. The first section 1311, the second section 1312, the third section 1313, the fourth section 1314 and the fifth section 1315 together surround the sixth section 1316 and the seventh section 1317. The sixth section 1316 is located between the first section 1311 and the third section 1313. The seventh section 1317 is located between the third section 1313 and the fifth section 1315. The sixth section 1316 and the seventh section 1317 are spaced apart from each other. The extending portion 132 is connected to a midsection of the third section 1313.

In this embodiment, the T-shaped exciter 13 can generate two frequency bands ranging from 17.7 gigahertz (GHz) to 20.2 GHz and from 27.5 GHz to 30 GHz through the design of the head portion 131 with a hollow structure and the sixth section 1316 and the seventh section 1317 being spaced apart from each other.

In this embodiment, a length L3 of the first section 1311 is, for example, 1.175 millimeters. A width W3 of the first section 1311 is, for example, 0.15 millimeters. A length L4 of the second section 1312 is, for example, 0.5 millimeters. A width W4 of the second section 1312 is, for example, 0.2 millimeters. A length L5 of the third section 1313 is, for example, 2.5 millimeters. A width W5 of the third section 1313 is, for example, 0.1 millimeters. A length L6 of the fourth section 1314 is, for example, 0.5 millimeters. A width W6 of the fourth section 1314 is, for example, 0.2 millimeters. A length L7 of the fifth section 1315 is, for example, 1.175 millimeters. A width W7 of the fifth section 1315 is, for example, 0.15 millimeters. A length L8 of the sixth section 1316 and a length L9 of the seventh section 1317 are, for example, 0.73 millimeters. A distance D1 between the first section 1311 and the fifth section 1315 is, for example, 0.15 millimeters. A width W8 of the extending portion 132 is, for example, 0.8 millimeters.

The radiator 14 is disposed on the second top surface 122, and is, for example, made of copper foil. The radiator 14 includes two first radiation components 141 and two second radiation components 142. A size of each of the two first radiation components 141 is, for example, different from a size of each of the two second radiation components 142. For example, the size of each of the two first radiation components 141 is greater than the size of each of the two second radiation components 142. The two first radiation components 141 with larger size are configured to generate and radiate low frequency signals. The two second radiation components 142 with smaller size are configured to generate and radiate high frequency signals. The two first radiation components 141 are arranged along a diagonal of the radiator 14. The two second radiation components 142 are arranged along another diagonal of the radiator 14. In addition, there is a distance between each of the two first radiation components 141 and each of the two second radiation components 142. Thus, impedance matching of the antenna device 10 can be improved and the electromagnetic wave band-pass effect can be achieved through the arrangement of the two first radiation components 141 and the two second radiation components 142.

In this embodiment, a length L10 of each of the two first radiation components 141 and a width W9 of each of the two first radiation components 141 are, for example, 2.75 millimeters. A length L11 of each of the two second radiation components 142 and a width W10 of each of the two second radiation components 142 are, for example, 2.4 millimeters. A distance D2 between each of the two first radiation components 141 and each of the two second radiation components 142 is, for example, 0.2 millimeters.

The coupling body 15 is disposed between the first top surface 112 and the second bottom surface 121, and is, for example, made of copper foil. The feeding point 16 is disposed at an end of the extending portion 132 farthest away from the head portion 131, and is configured for a signal to be fed into the antenna device 10. The coupling body 15 has a slot 151. The slot 151 is configured for coupling the signal to the radiator 14. A length L12 of the slot 151 is, for example, 3 millimeters. A width W11 of the slot 151 is, for example, 0.6 millimeters.

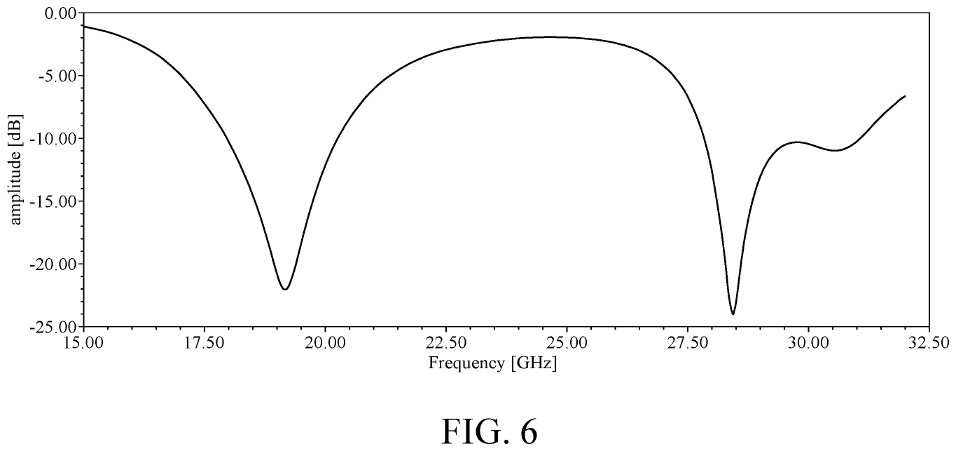

Please refer to FIG. 1 to FIG. 6, which is a graph showing a return loss data of the antenna device 10 in FIG. 1. In this embodiment, in the two frequency bands ranging from 17.7 GHz to 20.2 GHz and from 27.5 GHz to 30 GHz, the return losses of the antenna device 10 are low. In detail, in the two aforementioned frequency bands, the return losses of the antenna device 10 are mostly lower than −10 dB, so that the impedance matching of the antenna device 10 is good. In addition, generally, the higher the gain of the antenna is, the more concentrated the radiation from the antenna becomes, allowing the signal radiated from the antenna to be transmitted farther in a specific direction. In this embodiment, in the two aforementioned frequency bands, the antenna device 10, for example, has a maximum gain of 6.7 dBi.

In this embodiment, the size of each of the two first radiation components 141 and the size of each of the two second radiation components 142 are different, and the two first radiation components 141 and the two second radiation components 142 are arranged along the diagonals, respectively. In addition, the head portion 131 of the T-shaped exciter 13 has a hollow structure, and the sixth section 1316 and the seventh section 1317 of the T-shaped exciter 13 are spaced apart from each other. Thus, the T-shaped exciter 13 can generate the two frequency bands ranging from 17.7 GHz to 20.2 GHz and from 27.5 GHz to 30 GHz, and the return losses in the two frequency bands are low. Therefore, the stability and efficiency of communications between the antenna device 10 and low Earth orbit satellites can be improved.

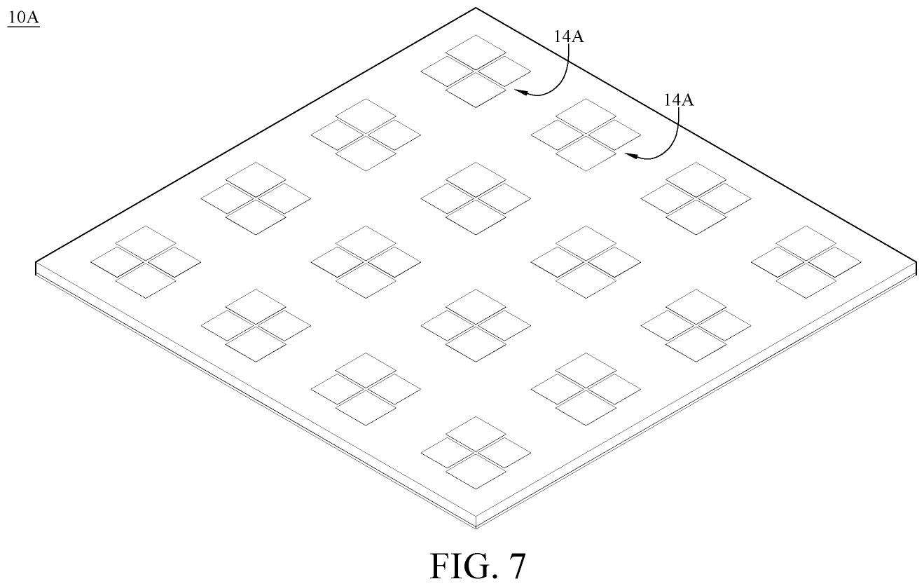

Please refer to FIG. 7, which is a perspective view of an antenna device 10A in accordance with second embodiment of the invention. The antenna device 10A of this embodiment is similar to the antenna device 10 of the first embodiment, the main difference between them will be described below, and the same parts between them can be referred to the aforementioned paragraphs with the reference to FIG. 1 to FIG. 6 and will not be repeatedly introduced hereinafter. In this embodiment, the antenna device 10A includes 16 radiators 14A, and the radiators 14A are arranged in, for example, a 4×4 array. Accordingly, by arranging the radiators 14A in an array, the antenna device 10A can achieve a significant gain superposition effect. In other embodiment, the antenna device may include other numbers of radiators arranged in an array according to a requirement for different electronic products.

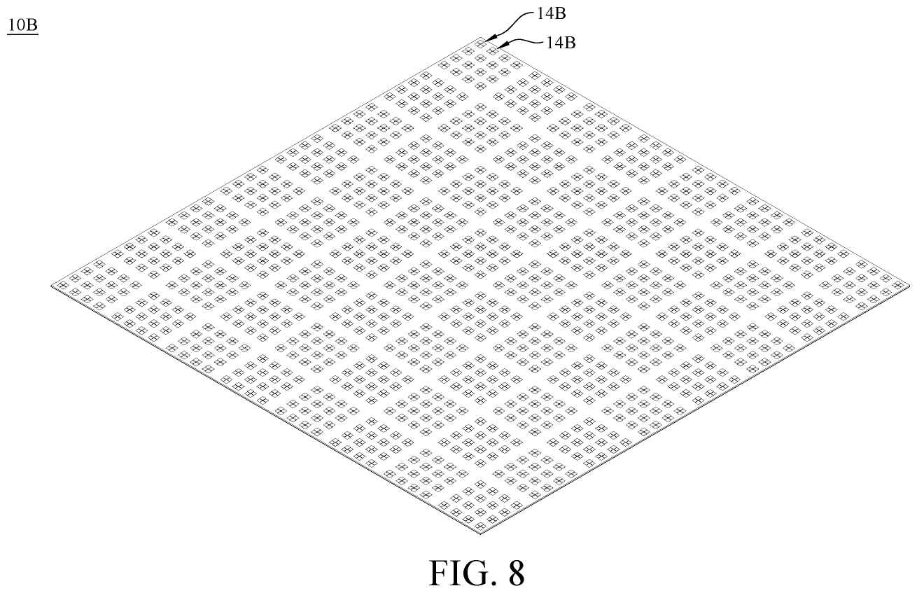

Please refer to FIG. 8, which is a perspective view of an antenna device 10B in accordance with third embodiment of the invention. The antenna device 10B of this embodiment is similar to the antenna device 10 of the first embodiment, the main difference between them will be described below, and the same parts between them can be referred to the aforementioned paragraphs with the reference to FIG. 1 to FIG. 6 and will not be repeatedly introduced hereinafter. In this embodiment, the antenna device 10B includes 1024 radiators 14B, and the radiators 14B are arranged in, for example, a 32×32 array. Accordingly, by arranging the radiators 14B in an array, the antenna device 10B can achieve a significant gain superposition effect. In other embodiment, the antenna device may include other numbers of radiators arranged in an array according to a requirement for different electronic products.

According to the antenna device disclosed by the above embodiments, the size of each of the two first radiation components is different from the size of each of the two second radiation components, and the two first radiation components and the two second radiation components are arranged along the diagonals, respectively. In addition, the head portion of the T-shaped exciter has a hollow structure, and the sixth section and the seventh section of the T-shaped exciter are spaced apart from each other. Thus, the T-shaped exciter can generate the two frequency bands ranging from 17.7 GHz to 20.2 GHz and from 27.5 GHz to 30 GHz, and the return losses in the two frequency bands are low. Therefore, the stability and efficiency of communications between the antenna device and low Earth orbit satellites can be improved.

It will be apparent to those skilled in the art that various modifications and variations can be made to the invention. It is intended that the specification and examples be considered as exemplary embodiments only, with the scope of the invention being indicated by the following claims.

What is claimed is:

1. An antenna device, comprising:
a first substrate, having a first bottom surface and a first top surface opposite to each other;
a second substrate, stacked on the first substrate, wherein the second substrate has a second bottom surface and a second top surface opposite to each other, and the second bottom surface faces the first top surface;
a T-shaped exciter, disposed on the first bottom surface, wherein the T-shaped exciter comprises a head portion and an extending portion, and the extending portion is connected to a side of the head portion; and
at least one radiator, disposed on the second top surface, wherein the at least one radiator comprises two first radiation components and two second radiation components, a size of each of the two first radiation components is different from a size of each of the two second radiation components, the two first radiation components are arranged along a diagonal of the at least one radiator, and the two second radiation components are arranged along another diagonal of the at least one radiator.

2. The antenna device according to claim 1, wherein the head portion of the T-shaped exciter comprises a first section, a second section, a third section, a fourth section, a fifth section, a sixth section and a seventh section, an end of the first section is connected to an end of the second section, another end of the second section is connected to an end of the third section, the first section and the third section are located on a same side of the second section, another end of the third section is connected to an end of the fourth section, the second section and the fourth section are located on a same side of the third section, another end of the fourth section is connected to an end of the fifth section, the third section and the fifth section are located on a same side of the fourth section, another end of the fifth section and another end of the first section are spaced apart from each other, the first section, the second section, the third section, the fourth section and the fifth section together surround the sixth section and the seventh section, the sixth section is located between the first section and the third section, the seventh section is located between the third section and the fifth section, the sixth section and the seventh section are spaced apart from each other, and the extending portion is connected to a midsection of the third section.

3. The antenna device according to claim 2, wherein a length of the first section is 1.175 millimeters, a width of the first section is 0.15 millimeters, a length of the second section is 0.5 millimeters, a width of the second section is 0.2 millimeters, a length of the third section is 2.5 millimeters, a width of the third section is 0.1 millimeters, a length of the fourth section is 0.5 millimeters, a width of the fourth section is 0.2 millimeters, a length of the fifth section is 1.175 millimeters, a width of the fifth section is 0.15 millimeters, a length of the sixth section and a length of the seventh section are 0.73 millimeters, a distance between the first section and the fifth section is 0.15 millimeters, and a width of the extending portion is 0.8 millimeters.

4. The antenna device according to claim 1, further comprising a coupling body and a feeding point, wherein the coupling body is disposed between the first top surface and the second bottom surface, the feeding point is disposed at an end of the extending portion farthest away from the head portion, the feeding point is configured for a signal to be fed into the antenna device, the coupling body has a slot, and the slot is configured for coupling the signal to the at least one radiator.

5. The antenna device according to claim 4, wherein a length of the slot is 3 millimeters, and a width of the slot is 0.6 millimeters.

6. The antenna device according to claim 4, wherein the T-shaped exciter, the at least one radiator and the coupling body are made of copper foil.

7. The antenna device according to claim 1, wherein the antenna device comprises a plurality of radiators, and the plurality of radiators are arranged in an array.

8. The antenna device according to claim 1, wherein a length of the first substrate, a width of the first substrate, a length of the second substrate and a width of the second substrate are 10 millimeters, a thickness of the first substrate is 0.8 millimeters, and a thickness of the second substrate is 0.2 millimeters.

9. The antenna device according to claim 1, wherein a length of each of the two first radiation components and a width of each of the two first radiation components are 2.75 millimeters, a length of each of the two second radiation components and a width of each of the two second radiation components are 2.4 millimeters, and a distance between each of the two first radiation components and each of the two second radiation components is 0.2 millimeters.

10. The antenna device according to claim 1, wherein the first substrate and the second substrate are made of glass fiber materials.
